(19) United States
(12) Patent Application Publication
(10) Pub. No.: US 2012/0135182 A1
(43) Pub. Date: May 31, 2012

(54) PLASTIC THREAD DOOR MAT AND A FORMING MOLD THEREOF

(76) Inventor: Larry YAO, Wu Chi Town (TW)

(21) Appl. No.: 12/956,044

(22) Filed: Nov. 30, 2010

(51) Int. Cl. B32B 33/00; B32B 3/02; A47L 23/22; B29C 65/02

(52) U.S. Cl. 428/92; 264/248

(57) ABSTRACT

The present invention relates to a plastic thread door mat and a forming mold thereof. By a high frequency heating mold, the edge of the plastic thread door mat is pressed by the specific molding closing structure of the forming mold to form a solid side. Through the solid side, the edge the plastic thread door mat is attached to the ground tightly, providing a better safety for a pedestrian.

### BACKGROUND OF THE INVENTION

1. Field of the Invention

The present invention relates to a plastic thread door mat and a forming mold thereof.

2. Description of the Prior Art

FIG. 1 is a sectional view of a conventional plastic door mat. The conventional plastic door mat includes a base 1 made of a plastic material and a meshed layer 2 made of curly plastic threads. The meshed layer 2 is attached to the base 1. The meshed layer 2 is able to filter sand, dust and water. The plastic thread door mat is widely used at the door of a house or a public place to prevent sand, dust or dirty water from entering the house. The plastic thread door mat can be cut in a desired shape and size for use. After cutting, the cutoff surface of the meshed layer 2 will have threads exposed irregularly, which results in an unattractive appear. In order to improve this situation, the edge of the plastic thread door mat will be pressed by a high temperature mold after cutting. After pressing, the edge of the plastic thread door mat will have a flat and smooth side 3. However, the side 3 of the plastic thread door mat usually has a certain thickness. When the plastic thread door mat is laid on the ground, the side 3 of the plastic thread door mat is easy to deform after a period of time. Thus, the side 3 of the plastic thread door mat may be slightly raised. When a pedestrian walks on the plastic thread door mat, he/she may be stumbled by the raised side 3. An external force also causes the side 3 of the plastic thread door mat to be raised increasingly, and the side 3 of the plastic thread door mat won't attach to the ground any longer. The plastic thread door mat may cause a slide, which is dangerous to the pedestrian.

Accordingly, the inventor of the present invention has devoted himself based on his many years of practical experiences to solve this problem.

### SUMMARY OF THE INVENTION

The primary object of the present invention is to provide a plastic thread door mat and a forming mold thereof. Through a high temperature mold to press the plastic thread door mat, the edge of the plastic thread door mat is pressed to form a solid side, so that the edge of the plastic thread door mat can be attached to the ground better. Thus, the plastic thread door mat is safe when in use.

According to a first aspect of the present invention, there is provided a plastic thread door mat. The plastic thread door mat comprises a base, a first side section, a second side section, and a thread-like mat body. The base is made of PVC. The first side section is continuous with a circumferential edge of the base. The first side section has a predetermined height extending from a top surface of the base. The second side section is continuous with a top end of the first side section. The second side section has a predetermined length extending outward and downward. The second side section has a free end inclined to be contact with the ground. The thread-like mat body is made of curly plastic threads which are irregularly piled up. The thread-like mat body is disposed on top of the base and located at an inner side of the first side section.

According to a first aspect of the present invention, there is provided a forming mold for a plastic thread door mat. The forming mold comprises an upper mold, a lower mold, and a heating device. The upper mold has a first mold cavity at a central portion of a bottom of the upper mold. The upper mold further has a second mold cavity at a circumferential portion of the bottom of the upper mold. The second mold cavity is a peak-shaped recess. The lower mold corresponds to the upper mold. The lower mold has a peak-shaped mold block on a top end thereof corresponding to the peak-shaped recess of the upper mold. The heating device is disposed on the forming mold. The heating device provides heat source to the forming mold when the forming mold proceeds with pressing. By the corresponding mold cavity and mold block of the upper and lower molds and the heating device to provide a heat source to the forming mold, the circumferential edge of the plastic thread door mat can be pressed to be a solid side. The plastic thread door mat of the present invention can prevent a pedestrian form being stumbled by the plastic thread door mat. The plastic thread door mat of the present invention is safe in use.

### BRIEF DESCRIPTION OF THE DRAWINGS

FIG. 1 is a sectional view of a conventional plastic door mat;

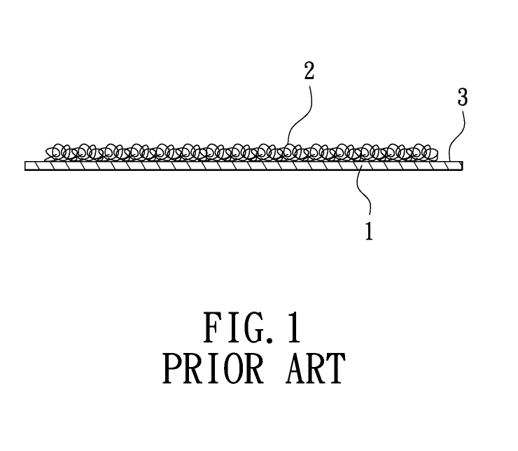

FIG. 2 is a top view showing a plastic thread door mat of the present invention;

FIG. 3 is a sectional view of the plastic thread door mat of the present invention;

FIG. 4 is a partial sectional view showing a forming mold of the present invention;

FIG. 5 is a partial sectional view of the plastic thread door mat of the present invention before mold closing; and

FIG. 6 is a partial sectional view of the plastic thread door mat of the present invention after mold closing.

### DETAILED DESCRIPTION OF THE PREFERRED EMBODIMENTS

Embodiments of the present invention will now be described, by way of example only, with reference to the accompanying drawings.

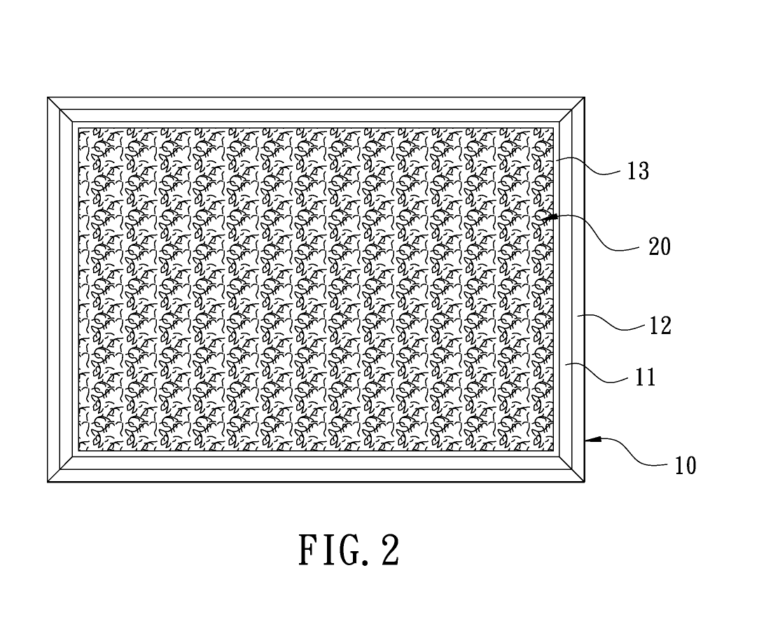

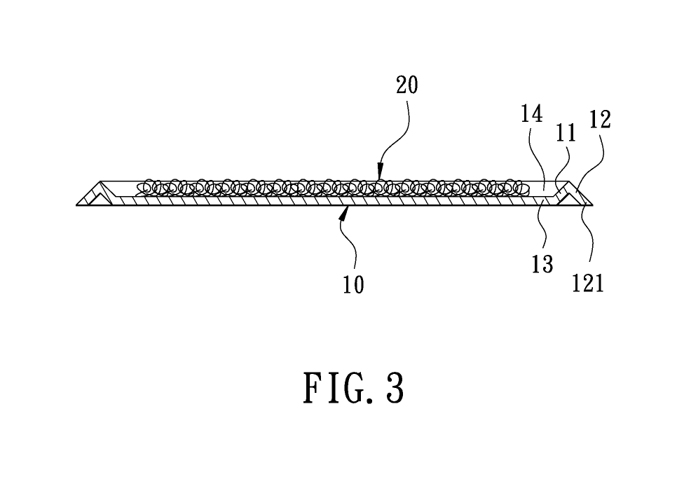

As shown in FIG. 2 and FIG. 3, a plastic thread door mat according to a preferred embodiment of the present invention comprises a base 10, a first side section 11, a second side section 12, a third side section 13, a groove 14, and a thread-like mat body 20.

The base 10 is in a rectangular shape and made of PVC.

The first side section 11 is continuous with a circumferential edge of the base 10 and has a predetermined height extending from a top surface of the base 10. The second side section 12 is continuous with a top end of the first side section 11 and has a predetermined length extending outward and downward. The second side section 12 has a free end.

One end of the third side section 13 is continuous with the circumferential edge of the base 10 and another end of the third side section 13 is continuous with a bottom end of the first side section 11, so that the groove 14 is formed above the third side section 13 and between the first side section 11 and the thread-like mat body 20.

The thread-like mat body 20 is disposed on top of the base 10 and located at an inner side of the first side section 11. The thread-like mat body 20 is made of curly plastic threads which are irregularly piled up.

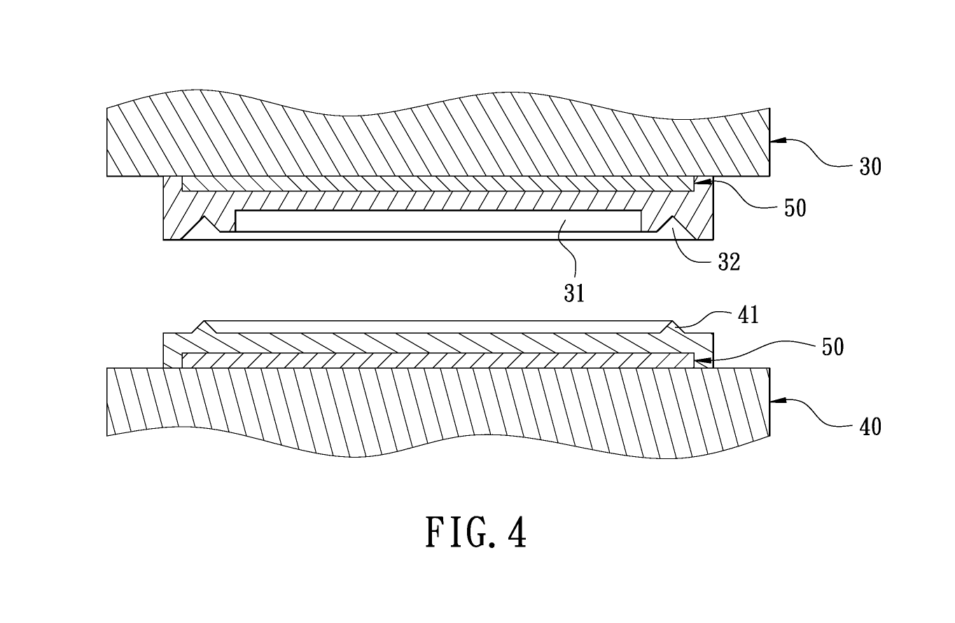

FIG. 4 is a partial sectional view showing a forming mold of the present invention. The forming mold comprises an upper mold 30, a lower mold 40 and a heating device 50. The upper mold 30 has a first mold cavity 31 at a central portion of a bottom of the upper mold 30. The upper mold 30 has a second mold cavity 32 at a circumferential portion of the bottom of the upper mold 30. The second mold cavity 32 is a peak-shaped recess. The lower mold 40 corresponds to the upper mold 30. The lower mold 40 has a peak-shaped mold block 41 on a top end thereof corresponding to the second mold cavity 32 of the upper mold 30. The heating device 50 is disposed on the forming mold.

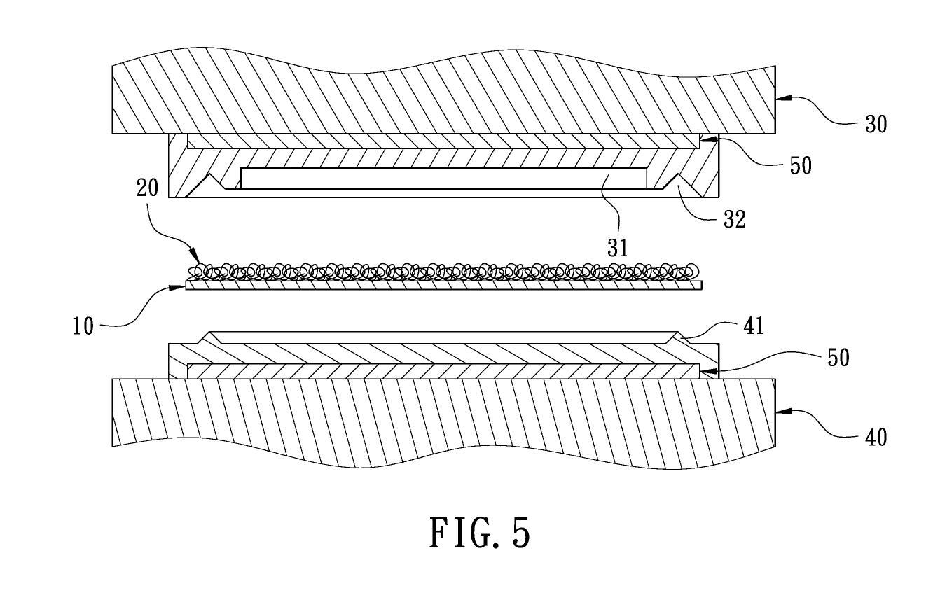

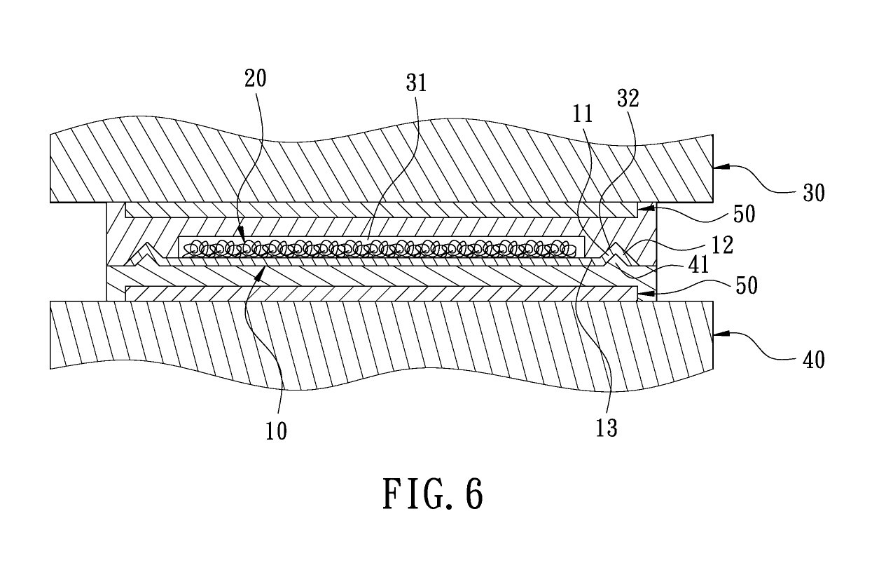

FIG. 5 is a partial sectional view of the plastic thread door mat of the present invention before mold closing. The plastic thread door mat is first cut in a desired size and shape and placed on top of the lower mold 40, and then the heating device 50 is started. The heating device 50 can be a high frequency heating device. FIG. 6 is a partial sectional view of the plastic thread door mat of the present invention after mold closing. When the forming mold proceeds with pressing, the heating device 50 will provide a heat source to the forming mold. After that, the upper mold 30 is pressed downward to joint the circumferential edges of the base 10 and the thread-like mat body 20 by fusion. The second mold cavity 32 of the upper mold 30 and the peak-shaped mold block 41 of the upper mold 40 are closed to form the first side section 11, the second side section 12 and the third side section 13, and then the upper mold 30 is retracted to take out the plastic thread door mat to complete the side pressing of the plastic thread door mat.

Furthermore, the base 10 is integrally formed with the first side section 11, the second side section 12 and the third side section 13 by the high-temperature pressing of the forming mold. The free end of the second side section 12 is inclined downward to be contact with the ground to form an oblique surface, so that the edge of the plastic thread door mat won't be easily raised upward by an external force to be attached to the ground well. The groove 14 above the second side section 13 is used to receive dirty water, avoiding the dirty water from flowing out of the plastic thread door mat. The plastic thread door mat of the present invention can prevent a pedestrian form being stumbled by the plastic thread door mat. The plastic thread door mat of the present invention is safe in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A plastic thread door mat, comprising:
a base made of PVC (polyvinyl chloride);
a first side section continuous with a circumferential edge of the base, the first side section having a predetermined height extending from a top surface of the base;
a second side section continuous with a top end of the first side section, the second side section having a predetermined length extending outward and downward, the second side section having a free end inclined to be contact with the ground; and
a thread-like mat body made of curly plastic threads which are irregularly piled up, the thread-like mat body being disposed on top of the base and located at an inner side of the first side section.

2. The plastic thread door mat as claimed in claim 1, wherein the base is integrally formed with the first side section and the second side section.

3. The plastic thread door mat as claimed in claim 1, wherein the base and the thread-like mat body are jointed by fusion.

4. The plastic thread door mat as claimed in claim 1, further comprising a third side section and a groove, one end of the third side section being continuous with the circumferential edge of the base and another end of the third side section being continuous with a bottom end of the first side section, the groove being formed above the third side section and between the first side section and the thread-like mat body.

5. A forming mold for a plastic thread door mat, comprising:
an upper mold having a first mold cavity at a central portion of a bottom of the upper mold, the upper mold further having a second mold cavity at a circumferential portion of the bottom of the upper mold, the second mold cavity being a peak-shaped recess;
a lower mold corresponding to the upper mold, the lower mold having a peak-shaped mold block on a top end thereof corresponding to the peak-shaped recess of the upper mold; and
a heating device disposed on the forming mold, the heating device providing heat source to the forming mold when the forming mold proceeds with pressing.

6. The forming mold as claimed in claim 5, wherein the heating device is a high frequency heating device.
